(19) United States
(12) Patent Application Publication
(10) Pub. No.: US 2010/0233524 A1
(43) Pub. Date: Sep. 16, 2010

(54) CYLINDRICAL NON-AQUEOUS ELECTROLYTE SECONDARY BATTERY

(76) Inventors: Yasuhiko Hina, Hyogo (JP); Akira Nagasaki, Osaka (JP); Tetsu Hashimoto, Osaka (JP)

Correspondence Address: MCDERMOTT WILL & EMERY LLP, 600 13TH STREET, NW, WASHINGTON, DC, 20005-3096, US

(21) Appl. No.: 12/675,296

(22) PCT Filed: May 26, 2009
(86) PCT No.: PCT/JP2009/002313

§ 371 Date: Feb. 25, 2010

(30) Foreign Application Priority Data
May 28, 2008 (JP) 2008-139466

(51) Int. Cl. H01M 10/04; H01M 2/02

(52) U.S. Cl. 429/164

(57) ABSTRACT

A cylindrical non-aqueous electrolyte secondary battery of the invention includes: an approximately columnar electrode group having a strip-shaped positive electrode including a positive electrode material mixture layer formed on a positive electrode current collector and a strip-shaped negative electrode including a negative electrode material mixture layer formed on a negative electrode current collector that are spirally wound with a strip-shaped separator interposed therebetween; a non-aqueous electrolyte; a bottomed cylindrical battery case housing the electrode group and the non-aqueous electrolyte; and a negative electrode lead electrically connecting the negative electrode and the battery case. The negative electrode includes a double-coated portion having a negative electrode material mixture layer formed on both surfaces of the negative electrode current collector, a single-coated portion having a negative electrode material mixture layer formed on one surface of the negative electrode current collector, and an uncoated portion where both surfaces of the negative electrode current collector are exposed. The single-coated and uncoated portions are disposed at an outermost layer of the electrode group. The negative electrode current collector exposed portions of the single-coated and uncoated portions are in direct contact with an inner surface of the battery case.

### RELATED APPLICATIONS

This application is the U.S. National Phase under 35 U.S.C. §371 of International Application No. PCT/JP2009/002313, filed on May 26, 2009, which in turn claims the benefit of Japanese Application No. 2008-139466, filed on May 28, 2008, the disclosures of which Applications are incorporated by reference herein.

### TECHNICAL FIELD

The present invention relates to a cylindrical non-aqueous electrolyte secondary battery that has a high capacity and superior safety in the event of an external short circuit.

### BACKGROUND ART

As more and more electronic devices have become portable and cordless, small and lightweight non-aqueous electrolyte secondary batteries with a high energy density are used as a power source for such devices. With the trend toward electronic devices with advanced functionality and high power consumption in recent years, demand for non-aqueous electrolyte secondary batteries with even higher energy density is increasing. Among non-aqueous electrolyte secondary batteries, increasing expectations are placed on lithium ion secondary batteries.

Generally, in non-aqueous electrolyte secondary batteries, in order to prevent an external short circuit or a significant temperature increase in the event of overcharging, protection mechanisms against overcurrent and temperature increases are provided such as a PTC (positive temperature coefficient) element and a thermostat. However, when various improper uses of batteries are considered, there is a possibility that an external short circuit that does not flow through such protection mechanisms might occur, causing thermal runaway in the battery. Such an external short circuit can be caused by deformation of the battery due to an excessive impact.

Thermal runaway in a battery will be described below. When an external short circuit that does not flow through the protection mechanisms mentioned above occurs, a short circuit current flows within the battery, a large amount of Joule heat is generated, and the battery temperature increases significantly. Among the regions in which such a short circuit current flows, a large amount of heat is generated, in particular, in a high resistance portion, that is, in the nickel negative electrode lead that connects the negative electrode and the battery case. Due to the heat generated in the negative electrode lead, the separator contracts and melts, causing an internal short circuit. Such an internal short circuit results in thermal runaway in the battery. Thermal runaway in a battery also occurs when the temperature of the negative electrode lead exceeds a heat resistance temperature of the active material due to the heat generation.

An example of a method for preventing such a thermal runaway caused by heat generation in a negative electrode lead has been proposed by Patent Document 1. Herein, in a non-aqueous electrolyte secondary battery that includes an electrode group in which a positive electrode and a negative electrode are spirally wound with a separator interposed between the positive electrode and the negative electrode, an uncoated portion in which no negative electrode material mixture layer is formed on both surfaces of a metal foil such that the metal foil is exposed is wound in two layers or more around the outermost layer of the electrode group, so that the uncoated portion is brought into direct contact with the inner surface of a battery case. With this configuration, the heat generated within the battery can be efficiently dissipated to the outside, and safety is improved.

### Prior Art Document

### Patent Document

Patent Document 1: Japanese Laid-Open Patent Publication No. H6-150973

### SUMMARY OF THE INVENTION

### Problem to be Solved by the Invention

However, according to Patent Document 1, it is difficult to achieve a higher capacity battery because the uncoated portion that does not contribute to battery capacity is disposed at the outermost layer of the electrode group.

In addition, because the uncoated portion disposed at the outermost layer of the electrode group is composed only of a low strength metal foil, the uncoated portion is likely to be displaced or deformed when inserting the electrode group into a battery case, which often results in a process failure. It is difficult to smoothly insert such an electrode group into a battery case without causing any displacement or deformation in the positive and negative electrodes. Even if a battery was produced, there is a high possibility that the positive electrode and the negative electrode might come into contact with each other due to a displacement or deformation in the uncoated portion, causing an internal short circuit. It is thus difficult to secure reliability.

Accordingly, with the method of Patent Document 1, it is difficult to simultaneously achieve improved safety, higher capacity and improved reliability.

Under the circumstances, in view of the problems encountered with such a conventional technique, it is an object of the present invention to provide a non-aqueous electrolyte secondary battery that has superior safety in the event of an external short circuit, a high capacity and a high level of reliability.

### Means for Solving the Problem

The present invention relates to a cylindrical non-aqueous electrolyte secondary battery including: an approximately columnar electrode group having a strip-shaped positive electrode including a positive electrode current collector and a positive electrode material mixture layer formed on the positive electrode current collector and a strip-shaped negative electrode including a negative electrode current collector and a negative electrode material mixture layer formed on the negative electrode current collector that are spirally wound with a strip-shaped separator interposed between the positive electrode and the negative electrode; a non-aqueous electrolyte; a bottomed cylindrical battery case that houses the electrode group and the non-aqueous electrolyte and that also serves as a negative electrode terminal; a negative electrode lead that electrically connects the negative electrode and the battery case; a battery lid that seals an opening of the battery case and that also serves as a positive electrode terminal; and a positive electrode lead that electrically connects the positive electrode and the battery lid,

wherein the negative electrode includes a double-coated portion in which the negative electrode material mixture layer is formed on both surfaces of the negative electrode current collector, a single-coated portion in which the negative electrode material mixture layer is formed on one surface of the negative electrode current collector, and an uncoated portion in which both surfaces of the negative electrode current collector are exposed,

the negative electrode material mixture layer of the double-coated portion and the single-coated portion faces the positive electrode material mixture layer with the separator interposed therebetween,

the single-coated portion and the uncoated portion are disposed at an outermost layer of the electrode group, and

the negative electrode current collector exposed portions of the single-coated portion and the uncoated portion are in direct contact with an inner surface of the battery case.

It is preferable that a ratio of a diameter of the electrode group relative to an inner diameter of the battery case is 95% or more and 99% or less.

It is preferable that the negative electrode lead is connected to a surface of the uncoated portion that faces an inner side surface of the battery case and an inner bottom surface of the battery case, and is in direct contact with the inner side surface of the battery case.

It is preferable that the negative electrode lead is connected to a surface of the uncoated portion that faces an inner side surface of the battery case and an inner bottom surface of the battery case, and an insulation tape is disposed between the negative electrode lead and the inner side surface of the battery case.

It is preferable that the separator is not present between the outermost layer of the electrode group and the inner surface of the battery case.

### Effect of the Invention

According to the present invention, no negative electrode material mixture layer is formed on the outer surface (a surface that faces the battery case) of the negative electrode that is disposed at the outermost layer of the electrode group to expose the negative electrode current collector so as to bring the negative electrode current collector into direct contact with the battery case, whereby the heat dissipation capability of the battery is improved, the heat generation of the battery in the event of an external short circuit is suppressed, and safety is improved.

In addition, a negative electrode material mixture layer that contributes to the battery capacity is formed on the inner surface (an opposite surface to the surface that faces the battery case) of the single-coated portion of the negative electrode that is disposed at the outermost layer of the electrode group, whereby a higher capacity battery can be achieved.

Furthermore, because the single-coated portion accounts for a large proportion of the outermost layer of the electrode group, unlike a conventional electrode group in which the outermost layer is composed only of a low strength metal foil, it is possible to suppress a displacement or deformation in the outermost layer when inserting the electrode group into a battery case, as well as suppressing an internal short circuit caused by such a displacement or deformation, and the reliability of the battery can be improved.

### BRIEF DESCRIPTION OF THE DRAWINGS

FIG. 1 is a schematic vertical cross-sectional view of a cylindrical lithium ion secondary battery as an embodiment of a cylindrical non-aqueous electrolyte secondary battery of the present invention.

FIG. 2 is a transverse cross-sectional view of a relevant part of an electrode group of FIG. 1.

FIG. 3 is a front view of a negative electrode used in the electrode group of FIG. 1.

FIG. 4 is a transverse cross-sectional view of the negative electrode of FIG. 3.

FIG. 5 is a transverse cross-sectional view of a relevant part of an electrode group of a cylindrical lithium ion secondary battery of Comparative Example 1.

FIG. 6 is a transverse cross-sectional view of a relevant part of an electrode group of a cylindrical lithium ion secondary battery of Comparative Example 2.

FIG. 7 is a transverse cross-sectional view of a relevant part of an electrode group of a conventional cylindrical lithium ion secondary battery of Comparative Example 3.

### MODE FOR CARRYING OUT THE INVENTION

A cylindrical non-aqueous electrolyte secondary battery of the present invention includes an approximately columnar electrode group having a strip-shaped positive electrode including a positive electrode current collector and a positive electrode material mixture layer formed on the positive electrode current collector and a strip-shaped negative electrode including a negative electrode current collector and a negative electrode material mixture layer formed on the negative electrode current collector that are spirally wound with a strip-shaped separator interposed between the positive electrode and the negative electrode; a non-aqueous electrolyte; a bottomed cylindrical battery case that houses the electrode group and the non-aqueous electrolyte and that also serves as a negative electrode terminal; a negative electrode lead that electrically connects the negative electrode and the battery case; a battery lid that seals an opening of the battery case and that also serves as a positive electrode terminal; and a positive electrode lead that electrically connects the positive electrode and the battery lid. The negative electrode includes a double-coated portion in which the negative electrode material mixture layer is formed on both surfaces of the negative electrode current collector, a single-coated portion in which the negative electrode material mixture layer is formed on one surface of the negative electrode current collector, and an uncoated portion in which both surfaces of the negative electrode current collector are exposed. The negative electrode material mixture layer of the double-coated portion and the single-coated portion faces the positive electrode material mixture layer with the separator interposed therebetween. The single-coated portion and the uncoated portion are disposed at an outermost layer of the electrode group. The negative electrode current collector exposed portions of the single-coated portion and the uncoated portion that are disposed on the same surface (outer surface) side are in direct contact with an inner surface of the battery case.

As described above, no negative electrode material mixture layer is provided on the outer surface (a surface that faces the inner side surface of the battery case) of the negative electrode that is disposed at the outermost layer of the electrode group to expose the negative electrode current collector so as to bring the negative electrode current collector into direct contact with the battery case. With this configuration, the heat dissipation capability of the battery is improved, the heat generation of the battery in the event of an external short circuit is suppressed, and safety is improved.

In addition, a negative electrode material mixture layer that contributes to the battery capacity is provided on the inner surface (an opposite surface to the surface that faces the inner side surface of the battery case) of the single-coated portion of the negative electrode that is disposed at the outermost layer of the electrode group. Accordingly, a higher capacity battery can be achieved.

Furthermore, because the single-coated portion accounts for a large proportion of the outermost layer of the electrode group, unlike a conventional electrode group in which the outermost layer is composed only of a low strength metal foil, it is possible to suppress a displacement or deformation in the outermost layer when inserting the electrode group into the battery case, as well as suppressing an internal short circuit caused by such a displacement or deformation, and thus, the reliability of the battery can be improved.

It is preferable that the ratio of the diameter of the electrode group when inserting it into a battery case relative to the inner diameter of the battery case (hereinafter referred to as ratio A) is 95% or more and 99% or less. When this is satisfied, a favorable contact state is obtained between the battery case and the electrode group, and the reliability of the battery is improved. As used herein, the diameter of the electrode group refers to the diameter of a cross section (approximately circular section) of the electrode group perpendicular to the axial direction of the battery. As the value of the diameter of the electrode group, a maximum value of the measured values obtained by, for example, measuring the diameter at a plurality of locations with the use of a vernier caliper or the like is used. Examples of a specific measurement method include a method in which the diameter is measured at four to eight points that are arbitrarily selected along the perimeter with a central angle of 45 to 90°, and a method in which the diameter is measured at all points along the perimeter with the use of a dial gage.

When the ratio A is 95% or more and 99% or less, a uniform and favorable contact state is secured between the negative electrode current collector exposed surface at the outermost layer of the electrode group and the inner surface of the battery case during charge and discharge. In the case of an electrode group in which the outermost layer is composed only of an uncoated portion, when the ratio A is within the above range, it is difficult to smoothly insert the electrode group in the manufacturing process. In contrast, according to the present invention, since a single-coated portion accounts for a large proportion of the outermost layer of the electrode group, the strength of the outermost layer of the electrode group is improved, and even when the ratio A is within the above range, a displacement or deformation in the outermost layer of the electrode group is suppressed.

Due to the expansion of positive and negative electrodes during charge and discharge, the diameter of an electrode group increases within the battery, increasing the contact area with the battery case. However, when the ratio A is less than 95%, it is difficult to obtain a uniform contact state, and variations may occur in the effect of improving safety. When, on the other hand, the ratio A exceeds 99%, the insertion pressure applied when inserting the electrode group into a battery case increases, so it may become difficult to insert the electrode group into a battery case during the battery manufacturing process. Even if such an electrode group was inserted into a battery case, there is a possibility that the positive electrode and the negative electrode might come into contact with each other due to a displacement or deformation in the positive and negative electrodes, causing an internal short circuit. More preferably, the ratio A is 98% or more and 99% or less.

It is preferable that the negative electrode lead is connected to an outer surface of the uncoated portion (a surface that faces the inner side surface of the battery case) and the inner bottom surface of the battery case, and is in direct contact with the inner side surface of the battery case. When an external short circuit that does not flow through a protection mechanism against overcurrent and temperature increases such as a PTC element or thermostat occurs, in the short circuit current flow path, a large amount of heat is generated, in particular, in a high resistance portion, or in other words, the negative electrode lead that electrically connects the negative electrode and the battery case. To address this, the negative electrode lead is brought into direct contact with other portion (the inner side surface of the battery case) than the welded portion of the inner bottom surface of the battery case, whereby the heat dissipation capability of the negative electrode lead is improved, and a local increase in the amount of heat generation in the negative electrode lead is suppressed, and thus, a battery temperature increase in the event of an external short circuit is suppressed significantly.

Also, it is preferable that the negative electrode lead is connected to a surface of the uncoated portion that faces the inner side surface of the battery case and the inner bottom surface of the battery case, and an insulation tape is disposed between the negative electrode lead and the inner side surface of the battery case. For example, an insulation tape may be attached to a surface of the negative electrode lead that faces the inner side surface of the battery case. By disposing an insulation tape, it becomes easier to insert the electrode group into a battery case, and productivity is improved.

The uncoated portion of the negative electrode is provided at the end of the outer layer side (winding end side) of the negative electrode as a portion to which a negative electrode lead is to be welded. In the positive electrode as well, an uncoated portion to which a positive electrode lead is to be welded is provided at a prescribed location (e.g., near a center portion in the longitudinal direction).

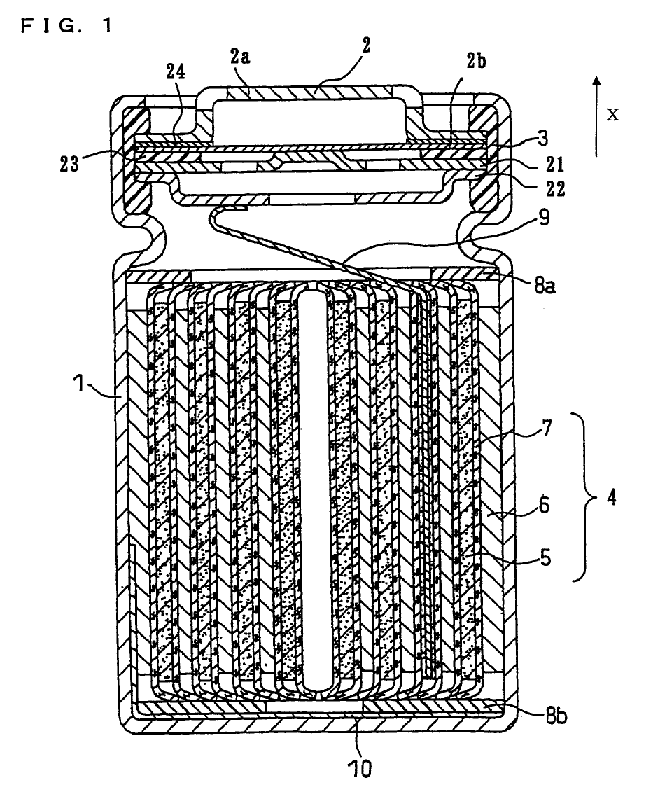

Hereinafter, the structure of a cylindrical lithium ion secondary battery as an embodiment of a non-aqueous electrolyte secondary battery of the present invention will be described with reference to FIG. 1. FIG. 1 is a schematic vertical cross-sectional view of a cylindrical lithium ion secondary battery as an embodiment of a non-aqueous electrolyte secondary battery of the present invention.

An approximately columnar electrode group 4 is housed in a bottomed cylindrical battery case 1 that also serves as a negative electrode terminal. The electrode group 4 is constructed by spirally winding a strip-shaped positive electrode 5 and a strip-shaped negative electrode 6 with a strip-shaped separator 7 interposed therebetween. The battery case 1 is made of, for example, copper, nickel, stainless steel or nickel-plated steel.

The positive electrode 5 includes a positive electrode current collector and a positive electrode material mixture layer formed on the positive electrode current collector. In part of the positive electrode 5, a portion having no positive electrode material mixture layer where the positive electrode current collector is exposed (hereinafter referred to as a positive electrode current collector exposed portion) is provided, and one end of a positive electrode lead 9 is connected to the positive electrode current collector exposed portion. The other end of the positive electrode lead 9 is connected to an under plate of a battery lid 2 that also serves as a positive electrode terminal.

The battery lid 2 includes a metal sealing plate 2a that has a flat portion serving as a positive electrode terminal in the center, a flat plate-like safety valve 2b that is electrically connected to a peripheral portion (a collar portion provided at the edge of the flat portion) of the sealing plate 2a with a ring-shaped PTC element 24 therebetween, a metal middle plate 21 that is electrically connected to a center portion of the safety valve 2b, a ring-shaped insulating plate 23 that is disposed between the peripheral portion of the safety valve 2b and a peripheral portion of the middle plate 21, and a dish-shaped metal under plate 22 that is electrically connected to the peripheral portion of the underside of the middle plate 21. The sealing plate 2a, the middle plate 21 and the under plate 22 have an air vent.

The safety valve 2b is made of a metal plate. When the internal pressure of the battery rises excessively, the center portion of the safety valve 2b deforms upward and separates from the middle plate 21, whereby the current is shut down. When the battery internal pressure further rises, the safety valve 2b is broken so as to release a gas to the outside of the battery. The PTC element 24 has a function of controlling a current that passes between the safety valve 2b and the peripheral portion of the sealing plate 2a according to the battery temperature. When the battery temperature rises excessively, the resistance of the PTC element increases significantly and the current flowing through the PTC element is reduced significantly.

The separator 7 is also present on the innermost layer of the electrode group 4. Insulating rings 8a and 8b are disposed on the top and bottom of the electrode group 4, respectively. The opening of the battery case 1 is sealed by crimping the opening end of the battery case 1 onto the peripheral portion of the battery lid 2 with a resin (e.g., polypropylene) gasket 3 interposed therebetween.

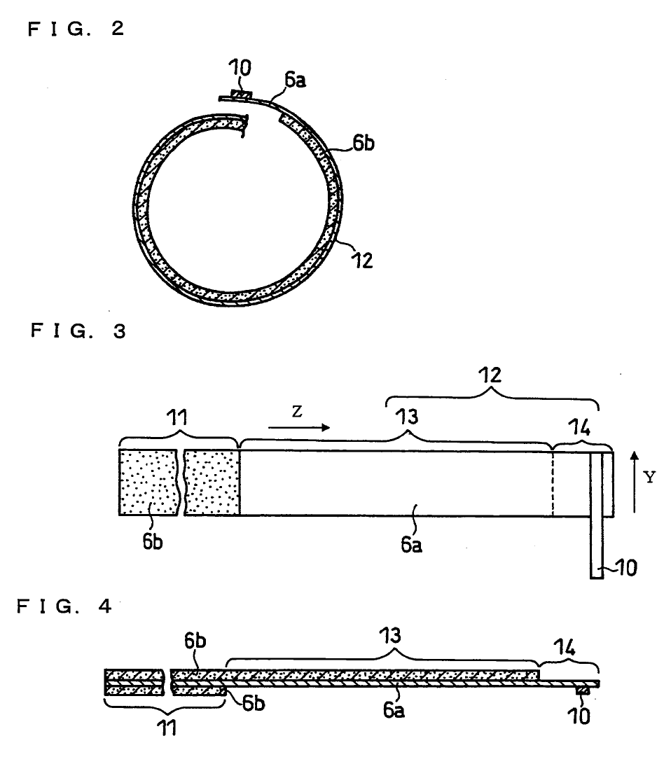

A transverse cross-sectional view (a cross-sectional view perpendicular to the axial direction X of the battery of FIG. 1) of a relevant part of the electrode group 4 of the lithium ion secondary battery of FIG. 1 is shown in FIG. 2. FIG. 2 shows only an outermost layer (winding end side of negative electrode 6) of the electrode group 4, and portions of the electrode group 4 other than the outermost layer are omitted. A front view of the negative electrode 6 is shown in FIG. 3, and a transverse cross-sectional view (a cross-sectional view perpendicular to the width direction Y of the negative electrode 6 of FIG. 3) of the negative electrode 6 is shown in FIG. 4.

As shown in FIGS. 2 to 4, the negative electrode 6 includes a double-coated portion 11 in which negative electrode material mixture layers 6b are formed on both surfaces of a negative electrode current collector 6a in the inner layer side from the outermost layer of the electrode group 4, a single-coated portion 13 in which a negative electrode material mixture layer 6b is formed on one surface of the negative electrode current collector 6a in the outermost layer of the electrode group 4, and an uncoated portion 14 in which no negative electrode material mixture layer 6b is formed on both surfaces of the negative electrode current collector 6a (in which the negative electrode current collector is exposed at both surfaces of the negative electrode 6).

The negative electrode material mixture layer 6b of the double-coated portion 11 and the single-coated portion 13 faces a positive electrode material mixture layer with the separator 7 interposed therebetween. The single-coated portion 13 is adjacent to the double-coated portion 11, and is provided to account for a large proportion of the outermost layer of the electrode group 4, and the surface in which no negative electrode material mixture layer 6b is formed (negative electrode current collector exposed surface) faces the battery case 1. The uncoated portion 14 is adjacent to the single-coated portion 13, and is provided at the winding end side of the negative electrode 6. The negative electrode current collector exposed portions 12 of the single-coated portion 13 and the uncoated portion 14 that are located at the outermost layer of the electrode group 4 are in direct contact with the inner side surface of the battery case 1. In the negative electrode current collector exposed portions 12 of FIG. 3, it is preferable that the single-coated portion 13 accounts for 50 to 95%.

A negative electrode lead 10 that connects the negative electrode 6 of the electrode group 4 and the battery case 1 is provided. One end of the negative electrode lead 10 is welded to the inner bottom surface of the battery case 1. The other end of the negative electrode lead 10 is welded to the outer layer surface (a surface that faces the battery case) of the uncoated portion 14, and the negative electrode lead 10 is in direct contact with the inner side surface of the battery case.

With this configuration, the heat dissipation capability of the battery is improved, so the heat generated within the battery in the event of an external short circuit can be efficiently dissipated to the outside of the battery. That is, in the event of an external short circuit, the short circuit current flows not only in the negative electrode lead portion, but also flows from the entire surface of the outermost layer of the electrode group (electrode group peripheral portion) toward the battery case, and the heat dissipation capability of the battery is therefore improved. Accordingly, battery safety in the event of an external short circuit is improved.

By bringing the negative electrode lead of a high resistance portion in which a large amount of heat is generated in the event of an external short circuit into direct contact with other portion (the inner side surface of the battery case) than the welded portion of the inner bottom surface of the battery case, heat is likely to be dissipated from the negative electrode lead directly via the battery case to the outside, and it is possible to further suppress local heat generation in the negative electrode lead.

Because the single-coated portion is disposed to account for a large proportion of the outermost layer of the electrode group, and a negative electrode material mixture layer that contributes to battery capacity is formed on the inner surface (an opposite surface to the surface that faces the battery case) of the single-coated portion, it is possible to achieve a higher capacity battery.

In a conventional battery, a separator is disposed on the outermost layer of an electrode group, but in the present invention, it is unnecessary to dispose a separator on the outermost layer of the electrode group, so cost reduction can be achieved. In addition, because a single-coated portion that has a negative electrode material mixture layer that contributes to battery capacity is disposed at the outermost layer of the electrode group, and the size of the electrode group (electrode thickness) can be increased to a region where a separator is conventionally disposed (a region that sufficiently and uniformly contacts with the battery case), a higher capacity can be achieved.

It is preferable that the ratio A (the ratio of the diameter of the electrode group 4 when inserting it into the battery case 1 relative to the inner diameter of the battery case 1) is 95% or more and 99% or less. As used herein, the diameter of the electrode group 4 refers to the diameter of a cross section (approximately circular section) of the electrode group 4 perpendicular to the axial direction X of the battery. In this case, the electrode group can be smoothly inserted into a battery case without causing a displacement or deformation in the electrode group, so a uniform and favorable contact state is obtained between the electrode group and the battery case. When the ratio A exceeds 99%, the insertion pressure applied when inserting the electrode group into a battery case is likely to increase, causing a displacement or deformation in the negative electrode at the outermost layer of the electrode group that is a process failure. It is difficult to smoothly insert an electrode group into a battery case without causing a displacement or deformation in the negative electrode at the outermost layer of the electrode group. Even if a battery was produced, an internal short circuit is likely to occur due to a displacement or deformation in the negative electrode at the outermost layer of the electrode group.

In addition, the diameter of the electrode group within a battery increases due to the expansion of the positive and negative electrodes during charge and discharge, and the contact area with the battery case increases, but when the ratio A is less than 95%, the diameter of the electrode group is too small, so a uniform contact state with the battery case is not obtained, and variations occur in the safety effect.

The effect of suppressing heat generation increases as the contact area of the negative electrode current collector exposed portion at the outermost layer of the electrode group with the battery case is increased. Accordingly, it is preferable that the ratio A is larger within the above range. More preferably, the ratio A is 98% or more and 99% or less.

The foregoing has described an example in which the negative electrode lead is disposed in the outer layer surface (a surface that faces the battery case) of the uncoated portion, but the negative electrode lead may be disposed in the inner surface (an opposite surface to the surface that faces the battery case) of the uncoated portion. Also, the foregoing has described an example in which the negative electrode lead is in direct contact with the inner side surface of the battery case, but the negative electrode lead may not necessarily be in direct contact with the inner side surface of the battery case.

For example, in FIG. 1 mentioned above, an insulation tape may be attached to a portion of the negative electrode lead 10 that faces the inner side surface of the battery case 1 (the portion that is connected to the uncoated portion 14 in FIG. 3). As the insulation tape, for example, a polypropylene tape with a thickness of 5 to 50 μm is used. A thinner insulation tape is more preferable.

In this case as well, by bringing the negative electrode current collector exposed portion of the single-coated portion and the uncoated portion into direct contact with the inner side surface of the battery case, the heat dissipation capability of the battery is improved, and the heat generated within the battery in the event of an external short circuit can be efficiently dissipated to the outside of the battery.

For the positive electrode lead 9, for example, aluminum or an aluminum alloy is used.

For the positive electrode current collector, for example, a metal foil (e.g., with a thickness of 1 to 500 μm, and preferably a thickness of 10 to 60 μm) such as an aluminum foil or an aluminum alloy foil is used.

The thickness of a positive electrode material mixture layer (on one surface) is preferably 20 to 150 μm.

A positive electrode material mixture layer contains, for example, a positive electrode active material, a binder and a conductive material.

As the positive electrode active material, for example, a lithium-containing composite oxide is used. Examples of a lithium-containing composite oxide include lithium cobalt oxide (LiCoO₂), a modified form of LiCoO₂, lithium nickel oxide (LiNiO₂), a modified form of LiNiO₂, lithium manganese oxide (LiMnO₂), and a modified form of LiMnO₂. Examples of such modified forms include those that contain an element such as aluminum (Al) or magnesium (Mg). Other examples of such modified forms include those that contain at least two selected from cobalt (Co), nickel (Ni) and manganese (Mn).

Examples of a positive electrode binder include a fluorocarbon resin such as polyvinylidene fluoride (PVDF) and a rubbery polymer that contains an acrylonitrile unit. From the viewpoint of exhibiting sufficient charge-discharge characteristics, it is preferable to use a rubbery polymer that contains an acrylonitrile unit and is capable of being swollen or wetted by a non-aqueous electrolyte, rather than PVDF. By the binder being swollen or wetted with an electrolyte, a path through which lithium ions migrate between the positive and negative electrodes during charge and discharge is created, and the charge-discharge characteristics are improved.

Examples of a positive electrode conductive material include carbon blacks such as acetylene black and ketjen black, graphite materials such as natural graphite and artificial graphite. These may be used alone or in a combination of two or more.

For the negative electrode lead 10, for example, nickel, copper, a clad material of nickel and copper, or nickel-plated copper is used. Preferred examples of the clad material include a material in which a copper plate and a nickel plate are superimposed, and a material in which a copper plate is sandwiched by nickel plates. In terms of ease of being welded to a battery case, nickel is preferable. In terms of low resistance, copper is preferable.

As the negative electrode current collector, for example, a metal foil (e.g., with a thickness of 1 to 500 μm, and preferably a thickness of 10 to 50 μm) such as a copper foil or a copper alloy foil is used.

The thickness of negative electrode material mixture layer 6b (on one surface) is, for example, 20 to 150 μm.

The negative electrode material mixture layer 6b contains, for example, a negative electrode active material and a binder. Examples of a negative electrode active material include various types of natural graphite, various types of artificial graphite, silicon-containing composite materials such as silicide, and various types of alloy materials. As a negative electrode binder, for example, PVDF or a modified form of PVDF is used.

A separator is made of, for example, a microporous monolayer made of a resin such as polypropylene or polyethylene, or a laminate in which a plurality of monolayers are laminated. From the viewpoint of securing insulation between positive and negative electrodes and retaining electrolyte, the thickness of the separator is preferably 10 μm or more. From the viewpoint of maintaining the design capacity of the battery, it is more preferable that the thickness of the separator is 30 μm or less.

A non-aqueous electrolyte contains, for example, a non-aqueous solvent and a lithium salt dissolved in the non-aqueous solvent. As the lithium salt, for example, lithium hexafluorophosphate (LiPF₆) or lithium tetrafluoroborate (LiBF₄) is used. Examples of a non-aqueous solvent include ethylene carbonate (EC), propylene carbonate (PC), dimethyl carbonate (DMC), diethyl carbonate (DEC), and methyl ethyl carbonate (MEC). They may be used alone or in a combination of two or more. It is also possible to add vinylene carbonate (VC), cyclohexylbenzene (CHB) or a modified form thereof to a non-aqueous electrolyte.

### EXAMPLES

Hereinafter, examples of the present invention will be described in detail, but it is to be understood that the present invention is not limited to the examples given below.

### Example 1

A cylindrical lithium ion secondary battery that has the same structure as that shown in FIG. 1 was produced in the following procedure.

### (1) Production of Positive Electrode

A positive electrode 5 was produced in the following manner. A positive electrode material mixture paste was obtained by agitating 3 kg of lithium cobalt oxide as a positive electrode active material, 1 kg of PVDF #1320 (trade name) (an N-methyl-2-pyrrolidone (hereinafter referred to simply as NMP) solution containing 12 wt % of PVDF) available from Kureha Chemical Industry Co., Ltd. as a binder, 90 g of acetylene black as a conductive material, and an appropriate amount of NMP with the use of a double arm kneader. The obtained positive electrode material mixture paste was applied onto a positive electrode current collector made of a 15 μm thick aluminum foil, dried and rolled so as to form positive electrode material mixture layers on the positive electrode current collector, whereby a plate-like positive electrode was obtained. Here, the thickness of the positive electrode including the positive electrode current collector and the positive electrode material mixture layers was 166 μm. The density of the positive electrode active material in the positive electrode material mixture layer was 3.6 g/cm³.

The positive electrode was cut into a strip shape with a size that could be inserted into a battery case (the length in the width direction: 56 mm, the length in the longitudinal direction: 580 mm). In part of the positive electrode, a positive electrode current collector exposed portion was provided.

### (2) Production of Negative Electrode

A negative electrode 6 was produced in the following manner. A negative electrode material mixture paste was obtained by agitating 3 kg of artificial graphite as a negative electrode active material, 75 g of BM-400B (trade name) (an aqueous dispersion containing 40 wt % of a styrene-butadiene copolymer (rubber particles)) available from Zeon Corporation, Japan as a binder, 30 g of carboxymethyl cellulose as a thickener and an appropriate amount of water with the use of a double arm kneader. The obtained negative electrode material mixture paste was applied onto a negative electrode current collector made of a 10 μm thick copper foil, dried and rolled so as to form negative electrode material mixture layers on the negative electrode current collector, whereby a plate-like negative electrode was obtained. Here, the thickness of the negative electrode including the negative electrode current collector and the negative electrode material mixture layers was 166 μm. The density of the negative electrode active material in the negative electrode material mixture layer was 1.6 g/cm³.

The negative electrode was cut into a strip shape with a size that could be inserted into a battery case (the length in the width direction Y: 58 mm, the length in the longitudinal direction Z: 650 mm). In a portion of the negative electrode that is disposed at the outermost layer of the electrode group, an uncoated portion 14 (the length in the longitudinal direction Z: 10 mm) and a single-coated portion 13 (the length in the longitudinal direction Z: 50 mm) were provided.

### (3) Preparation of Electrolyte

An electrolyte was prepared by dissolving LiPF₆ at a concentration of 1 mol/L in a non-aqueous solvent obtained by mixing EC and MEC at a volume ratio of 1:3.

### (4) Assembly of Battery

A nickel negative electrode lead 10 (thickness: 0.15 mm, width: 4 mm) was spot-welded to one surface (a surface that faces the battery case, which will be described later) of the uncoated portion 14 of the negative electrode 6 obtained above.

An aluminum positive electrode lead 9 (thickness: 0.15 mm, width: 3.5 mm) was spot-welded to an uncoated portion of the positive electrode 5 obtained above.

After that, the positive electrode 5 and the negative electrode 6 were spirally wound with a separator 7 interposed between the positive electrode 5 and the negative electrode 6 so as to construct an electrode group 4. A microporous polyethylene film with a thickness of 16 μm was used as the separator 7. At this time, the electrode group 4 was constructed such that the single-coated portion 13 and the uncoated portion 14 of the negative electrode were disposed at the outermost layer of the electrode group, and that the negative electrode lead 10 and the negative electrode current collector exposed portion 12 were located on the outer side of the layer (a surface that faces the battery case). The electrode group 4 was inserted into a bottomed cylindrical stainless steel battery case 1. The ratio A of the diameter of the electrode group when inserted into the battery case relative to the inner diameter of the battery case was 98%. The diameter of the electrode group was measured by using a dial gage (available from Mitutoyo Corporation, ID-C112). At all points on the perimeter of the electrode group were measured the diameters by using the dial gage, and the maximum value was defined as the diameter of the electrode group.

Insulating rings 8a and 8b were disposed on the top and bottom of the electrode group 4. An end of the negative electrode lead 10 was welded to the inner bottom surface of the battery case 1, and an end of the positive electrode lead 9 was welded to the underside of a battery lid 2. The non-aqueous electrolyte obtained above was injected into the battery case 1 in an amount of 5.5 g. The opening end of the battery case 1 was crimped onto the peripheral portion of the battery lid 2 with a gasket 3 interposed therebetween so as to seal the battery case 1. In this manner, a 18650 size cylindrical lithium ion secondary battery (diameter: 18 mm, height: 65 mm) was produced.

### Example 2

A battery was produced in the same manner as in Example 1, except that an insulation tape was attached to the surface of the negative electrode lead that faced the inner side surface of the battery case. As the insulation tape, a 30 μm thick polypropylene tape was used.

### Example 3

A battery was produced in the same manner as in Example 1, except that the positive electrode thickness was changed to 172 μm and the negative electrode thickness was changed to 172 μm by adjusting the amounts of the positive and negative electrode material mixture pastes applied to the positive and negative electrode current collectors, respectively, and the ratio A was changed to 99%.

### Example 4

A battery was produced in the same manner as in Example 1, except that the positive electrode thickness was changed to 154 μm and the negative electrode thickness was changed to 154 μm by adjusting the amounts of the positive and negative electrode material mixture pastes applied to the positive and negative electrode current collectors, respectively, and the ratio A was changed to 95%.

### Comparative Example 1

The positive electrode thickness was changed to 179 μm and the negative electrode thickness was changed to 179 μm by adjusting the amounts of the positive and negative electrode material mixture pastes applied to the positive and negative electrode current collectors, respectively.

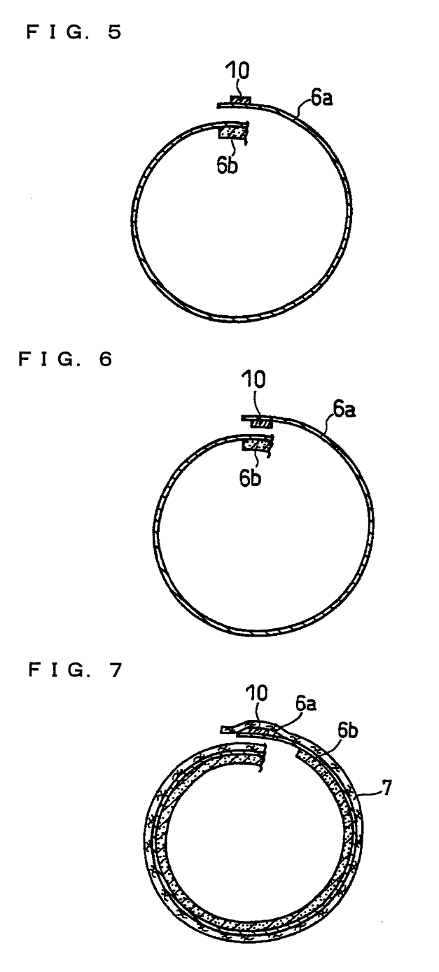

The single-coated portion of the negative electrode was changed to an uncoated portion. That is, an uncoated portion with a length of 60 mm in the longitudinal direction was provided such that it accounted for the entire outermost layer of the electrode group as shown in FIG. 5.

From the viewpoint of manufacturing process reliability, the ratio A was set to 95%. The strength of the outermost layer becomes smaller in an electrode group in which an uncoated portion (only a negative electrode current collector (copper foil)) is disposed in the entire outermost layer than in an electrode group in which a single-coated portion is disposed at the outermost layer, and when the ratio A exceeds 95%, defects such as a deformation and a displacement may occur in the negative electrode at the outermost layer of the electrode group when inserting it into a battery case.

A battery was produced in the same manner as in Example 1 except for the above points.

### Comparative Example 2

A battery was produced in the same manner as in Comparative Example 1, except that a negative electrode lead was welded to the surface of the uncoated portion that was opposite the surface that faced the battery case so as not to bring the negative electrode lead into direct contact with the battery case except for the portion welded to the inner bottom surface of the battery case as shown in FIG. 6.

### Reference Example 1

A battery was produced in the same manner as in Example 1, except that the positive electrode thickness was changed to 173 μm and the negative electrode thickness was changed to 173 μm by adjusting the amounts of the positive and negative electrode material mixture pastes applied to the positive and negative electrode current collectors, respectively, and the ratio A was changed to 99.5%.

### Reference Example 2

A battery was produced in the same manner as in Example 1, except that the positive electrode thickness was changed to 153 μm and the negative electrode thickness was changed to 153 μm by adjusting the amounts of the positive and negative electrode material mixture pastes applied to the positive and negative electrode current collectors, respectively, and the ratio A was changed to 94.5%.

### Comparative Example 3

The positive electrode thickness was changed to 164 μm and the negative electrode thickness was changed to 164 μm by adjusting the amounts of the positive and negative electrode material mixture pastes applied to the positive and negative electrode current collectors, respectively. Then, as shown in FIG. 7, an electrode group was constructed by disposing a separator on an opposite surface to the surface of the negative electrode that faced the positive electrode so as to dispose the separator on the outermost layer of the electrode group (or in other words, between the negative electrode of the electrode group and the battery case).

A battery was produced in the same manner as in Example 1, except that the above electrode group was used.

### Evaluation

(1) Test of Insertion of Electrode Group into Battery Case

Fifty electrode groups were prepared for each of Examples 1 to 4, Reference Examples 1 and 2 and Comparative Examples 1 to 3. Each electrode group was inserted into a battery case and, then, the state of the electrode group (the positive and negative electrodes) inserted into a battery case was checked by X-ray so as to determine the number of electrode groups in which the positive and negative electrodes had been displaced when inserting into a battery case out of 50 electrode groups. The results of the evaluation are shown in Table 1.

TABLE 1

| | | Number of Electrode Groups in |
|---|---|---|
| | | which Displacement Occurred in |
| | | Positive and Negative |
| | | Electrodes/Number of Electrode |
| | Ratio A (%) | Groups Tested |
| Ex. 1 | 98 | 0/50 |
| Ex. 2 | 98 | 0/50 |
| Ex. 3 | 99 | 0/50 |
| Ex. 4 | 95 | 0/50 |
| Comp. Ex. 1 | 95 | 0/50 |
| Comp. Ex. 2 | 95 | 0/50 |
| Ref. Ex. 1 | 99.5 | 2/50 |
| Ref. Ex. 2 | 94.5 | 0/50 |
| Comp. Ex. 3 | 98 | 0/50 |

In Examples 1 to 4, Comparative Examples 1 to 3 and Reference Example 2, no displacement had occurred in the positive and negative electrodes when inserting the electrode group into a battery case.

In Reference Example 1 in which the ratio A was 99.5%, electrode groups in which the positive and negative electrode had been displaced when inserted into a battery case due to the increased diameter of the electrode group and the increased insertion pressure of the electrode group were observed. When positive and negative electrodes are displaced, there is a possibility that the positive electrode and the negative electrode might come into contact with each other and short circuit. The use of the electrode group of Reference Example 1 resulted in reduced battery reliability.

In the case of an electrode group in which the outermost layer was a single-coated portion and the ratio A was not greater than 99%, it was possible to reliably insert the electrode group into a battery case without causing a displacement in the positive and negative electrodes.

In an electrode group in which the outermost layer was composed only of an uncoated portion such as the electrode groups of Comparative Examples 1 and 2, when the ratio A exceeded 95%, a displacement occurred in the uncoated portion of the outermost layer of the electrode group when inserting the electrode group into a battery case. This is because it is difficult to bring the outermost layer of the electrode group into close contact with a member located on the inner layer side (a separator or negative electrode), and the outermost layer is composed only of a low strength thin metal foil (negative electrode current collector).

### (2) Charge/Discharge Test

At an ambient temperature of 25° C., a battery was charged at a constant current of 0.7 ItmA to a closed circuit voltage of 4.2 V. After the battery had reached a closed circuit voltage of 4.2 V, the battery was charged at a constant voltage of 4.2 V to a current value of 50 mA. After charging, the battery was discharged at a constant current of 0.2 ItmA to a closed circuit voltage of 3.0 V, and the discharge capacity was determined. The test results are shown in Table 2.

As used herein, “It” represents a current, and rated capacity is defined by It(mA)/X(h)=rated capacity (mAh)/X(h), where X represents the time required to charge or discharge electricity in an amount of a rated capacity in X hours. For example, 0.5 ItmA means that the current value has a value of “rated capacity (mAh)/2(h)”.

TABLE 2

| | Discharge Capacity (mAh) |
|---|---|
| Ex. 1 | 2551 |
| Ex. 2 | 2551 |
| Ex. 3 | 2652 |
| Ex. 4 | 2349 |
| Comp. Ex. 1 | 2321 |
| Comp. Ex. 2 | 2321 |
| Ref. Ex. 1 | 2669 |
| Ref. Ex. 2 | 2332 |
| Comp. Ex. 3 | 2517 |

In the batteries of Examples 1 to 4, a higher capacity was exhibited as the ratio A (electrode thickness) was increased. Specifically, the battery of Example 3 exhibited the highest capacity, followed by the batteries of Examples 1 and 2, and the battery of Example 4.

The batteries of Examples 1 and 2 exhibited a higher capacity than the battery of Comparative Example 3 although the diameter of the electrode group was the same as that of the battery of Comparative Example 3. This is because in the batteries of Examples 1 and 2, a single-coated portion was disposed at the outermost layer of the electrode group, and the diameter (electrode thickness) of the electrode group could be increased to the portion in which a separator was disposed (a region that sufficiently and uniformly contacted with the battery case) on the outermost layer of the electrode group of Comparative Example 3.

The battery of Example 4 exhibited a higher capacity than the batteries of Comparative Examples 1 and 2 although the diameter of the electrode group was the same as that of the batteries of Comparative Examples 1 and 2. This is because in the batteries of Comparative Examples 1 and 2, an uncoated portion that does not contribute to battery capacity was disposed at the outermost layer of the electrode group, whereas in the battery of Example 4, a single-coated portion that included a negative electrode material mixture layer contributing to battery capacity was disposed at the outermost layer of the electrode group.

In the case of an electrode group in which the outermost layer is composed only of an uncoated portion such as the electrode groups of Comparative Examples 1 and 2, it is difficult to achieve a battery with a higher energy density (with a higher capacity) because the uncoated portion does not contribute to battery capacity and it is difficult to set the ratio A to exceed 95% for manufacturing process reasons.

The battery of Reference Example 1 exhibited a high capacity because the electrode group had a large diameter (electrode thickness), or in other words, the amount of active material was large. However, the battery of Reference Example 1 exhibited reduced reliability because a displacement could occur in the positive and negative electrodes when inserting the electrode group into a battery case as described above. In Reference Example 2, because the electrode group had a small diameter (electrode thickness), or in other words, the amount of active material was small, the discharge capacity was reduced.

### (3) External Short Circuit Test

At an ambient temperature of 25° C., a battery was charged at a constant current of 0.7 ItmA to a closed circuit voltage of 4.25 V. After the battery had reached a closed circuit voltage of 4.25 V, the battery was charged at a constant voltage of 4.25 V to a current value of 50 mA.

The charged battery was externally short-circuited in an environment of 60° C. The external short circuit current path was set not to include the battery lid 2 (PTC element 24). Specifically, a positive electrode lead 9 was drawn out of the battery and the positive electrode lead 9 was brought into contact with a battery case 1, assuming that an external short circuit had occurred due to the positive electrode lead 9 coming into contact with the battery case 1 by deformation of the battery by an external impact.

Then, the surface temperature was measured in a location on the battery case that faced the negative electrode lead, and a maximum battery temperature was determined. The battery surface temperature was measured by using a thermocouple.

When a battery reached a maximum battery temperature of 120° C. or more at which separator melt-down occurs, the battery was rated as defective. The number of batteries tested was three for each example. The test results are shown in Table 3.

TABLE 3

| | | External Short Circuit Test | |
|---|---|---|---|
| | | Number of | |
| | | Defective | |
| | | Batteries/ | |
| | | Number of | Maximum Battery |
| | Members in Contact with Inner Side Surface of Battery Case | Batteries Tested | Temperature (° C.) |
| Ex. 1 | Negative electrode current collector (single-coated | 0/3 | 96, 99, 102 |
| | portion), Negative electrode lead | | |
| Ex. 2 | Negative electrode current collector (single-coated | 0/3 | 99, 102, 104 |
| | portion) | | |
| Ex. 3 | Negative electrode current collector (single-coated | 0/3 | 98, 103, 104 |
| | portion), Negative electrode lead | | |
| Ex. 4 | Negative electrode current collector (single-coated | 0/3 | 98, 101, 103 |
| | portion), Negative electrode lead | | |
| Comp. Ex. 1 | Negative electrode current collector (uncoated portion), | 0/3 | 97, 100, 102 |
| | Negative electrode lead | | |
| Comp. Ex. 2 | Negative electrode current collector (uncoated portion) | 0/3 | 109, 113, 114 |
| Ref. Ex. 1 | Negative electrode current collector (single-coated | 0/3 | 99, 101, 107 |
| | portion), Negative electrode lead | | |
| Ref. Ex. 2 | Negative electrode current collector (single-coated | 1/3 | 97, 102, 123 |
| | portion), Negative electrode lead | | |
| Comp. Ex. 3 | Separator | 2/3 | 118, 142, 151 |

The maximum battery temperatures of the batteries of Examples 1 to 4 were 96 to 104° C. (not greater than 120° C.)

The reason for this is presumably as follows. In the batteries of Examples 1 to 4 in which the ratio A was 95% or more and 99% or less, the diameter of the electrode group increased due to the expansion of the positive and negative electrodes during charge and discharge, whereby the negative electrode current collector exposed portion of the single-coated portion and the uncoated portion at the outermost layer of the electrode group were brought into direct contact with the inner side surface of the battery case, or in addition to the negative electrode current collector exposed portion at the outermost layer of the electrode group being brought into contact with the inner side surface of the battery case, the negative electrode lead was brought into direct contact with the inner side surface of the battery case other than the welded portion to the battery case. Accordingly, as compared to a conventional configuration in which the contact portion of the negative electrode lead with a battery case is only a portion welded to the inner bottom surface of the battery case, the short circuit current path was secured over a wider region, as a result of which the short circuit current spread and heat generation during short circuiting was suppressed.

The batteries of Comparative Examples 1 and 2 and Reference Example 1 also exhibited a maximum battery temperature of not greater than 120° C. However, it was difficult to achieve a higher capacity in the batteries of Comparative Examples 1 and 2 as described above. The battery of Reference Example 1 exhibited reduced reliability as described above. The batteries of Comparative Example 2 exhibited a maximum battery temperature higher than those of the batteries of Comparative Example 1 by about 10° C. This is presumably because in the battery of Comparative Example 2, the negative electrode lead that generates a large amount of heat in the event of an external short circuit is in contact only with the portion welded to the inner bottom portion of the battery case, and the effect of dissipating heat was reduced.

In Reference Example 2, because the ratio A was less than 95% and the diameter of the electrode group was small, even when the diameter of the electrode group increased due to the expansion of the positive and negative electrodes during charge and discharge, a favorable contact state with the battery case was not obtained, so the short circuit current path was reduced, and a battery which produced a large amount of heat in the event of an external short circuit was observed.

The battery of Comparative Example 3 was disassembled and checked after the external short circuit test, and it was found that the separator melted at a location that faced the negative electrode lead, and the positive and negative electrodes were in contact with each other and short-circuited at that location. This is presumably because the amount of heat generated increased locally in the negative electrode lead during external short circuiting.

As described above, the batteries of Examples 1 to 4 exhibited improved safety in the event of an external short circuit, improved reliability and a high capacity.

### INDUSTRIAL APPLICABILITY

The non-aqueous electrolyte secondary battery of the present invention is suitable for use as a power source for electronic devices such as portable devices including notebook personal computers.

1. A cylindrical non-aqueous electrolyte secondary battery comprising:
an approximately columnar electrode group comprising a strip-shaped positive electrode including a positive electrode current collector and a positive electrode material mixture layer formed on said positive electrode current collector and a strip-shaped negative electrode including a negative electrode current collector and a negative electrode material mixture layer formed on said negative electrode current collector that are spirally wound with a strip-shaped separator interposed between said positive electrode and said negative electrode;
a non-aqueous electrolyte;
a bottomed cylindrical battery case that houses said electrode group and said non-aqueous electrolyte and that also serves as a negative electrode terminal;
a negative electrode lead that electrically connects said negative electrode and said battery case;
a battery lid that seals an opening of said battery case and that also serves as a positive electrode terminal; and
a positive electrode lead that electrically connects said positive electrode and said battery lid,
wherein said negative electrode comprises a double-coated portion in which said negative electrode material mixture layer is formed on both surfaces of said negative electrode current collector, a single-coated portion in which said negative electrode material mixture layer is formed on one surface of said negative electrode current collector, and an uncoated portion in which both surfaces of said negative electrode current collector are exposed,
the negative electrode material mixture layer of said double-coated portion and said single-coated portion faces said positive electrode material mixture layer with said separator interposed therebetween,
said single-coated portion and said uncoated portion are disposed at an outermost layer of said electrode group, and
the negative electrode current collector exposed portions of said single-coated portion and said uncoated portion are in direct contact with an inner surface of said battery case.

2. The cylindrical non-aqueous electrolyte secondary battery in accordance with claim 1, wherein a ratio of a diameter of said electrode group relative to an inner diameter of said battery case is 95% or more and 99% or less.

3. The cylindrical non-aqueous electrolyte secondary battery in accordance with claim 1, wherein said negative electrode lead is connected to a surface of said uncoated portion that faces an inner side surface of said battery case and an inner bottom surface of said battery case, and is in direct contact with the inner side surface of said battery case.

4. The cylindrical non-aqueous electrolyte secondary battery in accordance with claim 1, wherein said negative electrode lead is connected to a surface of said uncoated portion that faces an inner side surface of said battery case and an inner bottom surface of said battery case, and an insulation tape is disposed between said negative electrode lead and the inner side surface of said battery case.

5. The cylindrical non-aqueous electrolyte secondary battery in accordance with claim 1, wherein said separator is not present between the outermost layer of said electrode group and the inner surface of said battery case.
